(19) United States
(12) Patent Application Publication
(10) Pub. No.: US 2020/0066227 A1
(43) Pub. Date: Feb. 27, 2020

(54) CONTENT DISPLAY SYSTEM, DISPLAY DEVICE, DISPLAY METHOD AND PROGRAM

(71) Applicant: SHARP KABUSHIKI KAISHA, Sakai City (JP)

(72) Inventor: KOHJI KUMETANI, Sakai City (JP)

(21) Appl. No.: 16/540,488

(22) Filed: Aug. 14, 2019

(30) Foreign Application Priority Data
Aug. 22, 2018 (JP) 2018-155207

(51) Int. Cl. G09G 5/00

(52) U.S. Cl. CPC G09G 5/006; G09F 9/30; G09G 2380/06; G09G 2370/025

(57) ABSTRACT

In a content display system, a server device transmits, to a display device, a plurality of alternative content items including first alternative content corresponding to content, the display of which is controlled by a display control device, and second alternative content other than the first alternative content, and an alternative content display request for requesting display of at least one of the alternative content items. The display device stores the alternative content items received from the server device, determines the alternative content to be displayed from among the alternative content items when the alternative content display request is received, and displays the determined alternative content.

### BACKGROUND OF THE INVENTION

### Field of the Invention

The present invention relates to a content display system and the like.

### Description of the Background Art

In recent years, so-called digital signage, in which a display device is disposed at a place where many people gather such as a station yard and a shopping center and content such as an advertisement is displayed, is widely used as a content display device (see, for example, Japanese Unexamined Patent Publication No. 2015-35038).

In digital signage, it is general practice that, after a display device is installed, the distribution of content is received from a server for managing the display device, whereby the distributed content is displayed on the display device.

Further, various contrivances have been made to appropriately display content on the display device. For example, Japanese Unexamined. Patent Publication No. 2015-35038 discloses an image display apparatus including a Network I/F to acquire web content data via a network, and an external memory I/F configured to be connectable to an external memory for storing the web content data and acquire the web content data from the external memory. Furthermore, Japanese Unexamined Patent Publication No. 2015-35038 discloses the technology in which the image display device includes a web content selector that selects one of the web content data acquired via the network I/F and the web content data acquired via the external memory I/F, a web browser that interprets and draws the web content data selected by the web content selector, and a display panel that is a display portion that displays the drawing data drawn by the web browser, whereby image display can be continued even when a network failure occurs.

In the content display system used in the digital signage described above, if the display device receives the distribution of content while the display device is displaying content, jobs to be processed by the display device are increased, which may cause display problems such that the display of content is disturbed or be stopped.

Also, in recent years, there is a display device that has a simple reproduction function of enabling simple reproduction of content and that can reproduce (display) content by the simple reproduction function. Therefore, there has been proposed a technology for displaying, by means of the simple reproduction, previously stored content while the display device is receiving the distribution of content. According to this technology, it is possible to display content to be substituted for the content that is originally displayed, and to avoid the problem of impairing the quality and reliability as digital signage. However, in a case of managing content to be displayed by a contract with the advertiser, etc., it is desirable to reproduce content related to the content to be originally displayed as the content to be displayed instead of the content to be originally displayed.

In view of the above circumstances, an object of the present invention is to provide a content display system or the like that determines and displays alternative content to be displayed from among a plurality of alternative content items to be displayed instead of content.

### SUMMARY OF THE INVENTION

A content display system according to the present invention includes a server device which transmits content, a display device which displays the content, and a display control device which controls to display the content transmitted from the server device on the display device, wherein the server device includes a first controller which transmits, to the display device, a plurality of alternative content items including first alternative content corresponding to the content, the display of which is controlled by the display control device, and second alternative content other than the first alternative content, and controls to transmit an alternative content display request for requesting display of at least one of the alternative content items to the display device, and the display device includes a storage which stores the alternative content items received from the server device, and a second controller which determines the alternative content to be displayed from among the alternative content items when the alternative content display request is received, and controls to display the determined alternative content.

A display device of the present invention is connectable to a server device which transmits content and a display control device which performs display control based on the content transmitted from the server device, the display device including a controller which receives, from the server device, a plurality of alternative content items including first alternative content corresponding to the content, the display of which is controlled by the display control device, and second alternative content other than the first alternative content, receives an alternative content display request for requesting display of at least one of the alternative content items from the server device, determines the alternative content to be displayed from among the alternative content items when the alternative content display request is received, and controls to display the determined alternative content.

A display method of the present invention is a display method for a display device connectable to a server device which transmits content and a display control device which performs display control based on the content transmitted from the server device, the method including receiving, from the server device, a plurality of alternative content items including first alternative content corresponding to the content, the display of which is controlled by the display control device, and second alternative content other than the first alternative content, receiving an alternative content display request for requesting display of at least one of the alternative content items from the server device, determining alternative content to be displayed from among the alternative content items when the alternative content display request is received, and displaying the determined alternative content.

A program of the present invention causes the above display method to be implemented by a computer of a display device connectable to a server device which transmits content and a display control device which performs display control based on the content transmitted from the server device.

According to the present invention the display device can determine alternative content to be displayed from among the plurality of alternative content items transmitted from the server device, and display the alternative content. In this way, instead of simply displaying the stored alternative content, alternative content suitable for display can be determined and displayed among a plurality of the stored alternative content items.

### BRIEF DESCRIPTION OF THE DRAWINGS

FIG. 1 is a diagram for explaining an overall configuration of a content display system according to a first embodiment.

FIG. 2 is a diagram for explaining a functional configuration of a management server device according to the first embodiment.

FIG. 3 is a diagram illustrating an example of a data structure of schedule information according to the first embodiment.

FIG. 4 is a diagram illustrating an example of a data structure of priority information according to the first embodiment.

FIG. 5 is a diagram illustrating an example of a data structure of simple reproduction portion specification information according to the first embodiment.

FIG. 6 is a diagram for explaining a functional configuration of a control device according to the first embodiment.

FIG. 7 is a diagram for explaining a functional configuration of a display device according to the first embodiment.

FIG. 8 is a sequence diagram according to the first embodiment.

FIG. 9 is a flow diagram for explaining a flow of main processing of the management server device according to the first embodiment.

FIG. 10 is a flow diagram for explaining the flow of main processing of the management server device according to the first embodiment.

FIG. 11 is a flow diagram for explaining a flow of main processing of a control device according to the first embodiment.

FIG. 12 is a flow diagram for explaining a flow of main processing of a display device according to the first embodiment.

FIG. 13 is a flow diagram for explaining the flow of main processing of the display device according to the first embodiment.

FIG. 14A is a diagram showing an operation example according to the first embodiment, and FIG. 14B is a diagram showing an operation example according to the first embodiment.

FIG. 15A is a diagram showing an operation example according to the first embodiment, and FIG. 15B is a diagram showing an operation example according to the first embodiment.

FIG. 16A is a diagram showing an operation example according to the first embodiment, FIG. 16B is a diagram showing an operation example according to the first embodiment, and FIG. 16C is a diagram showing an operation example according to the first embodiment.

FIG. 17 is a diagram for explaining a functional configuration of a management server device according to a second embodiment.

FIG. 18 is a diagram for explaining a functional configuration of a display device according to the second embodiment.

### DESCRIPTION OF THE PREFERRED EMBODIMENTS

Hereinafter, embodiments of the present invention will be described with reference to the accompanying drawings. In the embodiments, a description will be given of a content display system to which the present invention is applied.

### 1. FIRST EMBODIMENT

### 1. 1. Overall Configuration

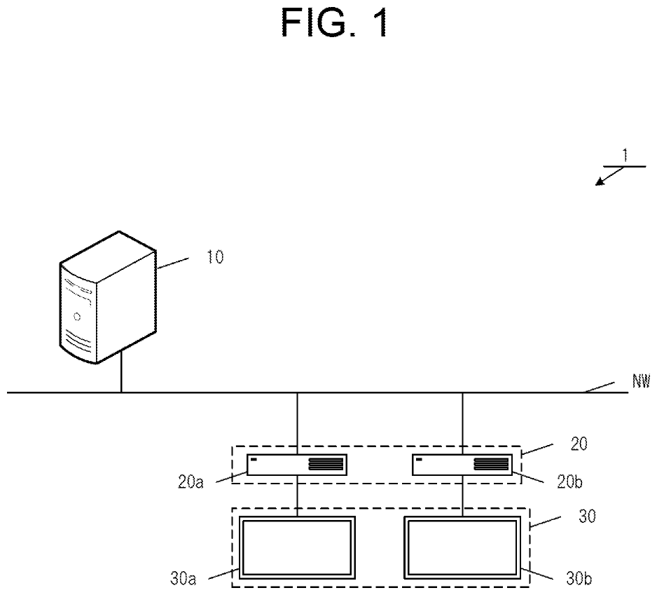

First, the overall configuration of the content display system 1 according to the present embodiment will be described based on FIG. 1. As shown in FIG. 1, in the content display system 1, a management server device 10, a control device 20, and a display device 30 are connected via a network NW.

Although FIG. 1 illustrates that the management server device 10, the control device 20 and the display device 30 are connected in the same network via a local area network (LAN), the devices may be connected in a configuration other than this connection configuration. For example, the management server device 10, the control device 20 and the display device 30 may be connected to each other via an external network such as the Internet. Also, the devices may be connected by another communicable means (for example, a serial interface such as RS-232C) instead of the LAN.

The management server device is a server that stores and transmits content to be transmitted (distributed) to the control device 20 and the display device 30. The management server device 10 is used by a service provider of digital signage such as an administrator or an advertiser, or by a person desiring to transmit content.

The control device 20 is a display control device which controls to display content received from the management server device 10 on display device 30. As shown in FIG. 1, a plurality of control devices 20 and a plurality of display devices 30 can be connected to the network NW. One or a plurality of display devices 30 may be connected to one control device 20. In the example of FIG. 1, the two control devices 20 including a control device 20a and a control device 20b are connected as the control device 20 to the network NW. A display device 30a is connected as the display device 30 to the control device 20a, and a display device 30b is connected as the display device 30 to the control device 20b.

The content in the present embodiment is data including a moving picture, a still picture, or a document that can be displayed on the display device 30. For example, the data is expressed as a file, and if it is moving picture content, it is displayed on the display device 30 by reproducing and outputting a moving picture file (for example, a mpg file, a wmv file or an avi file) stored in the control device 20. In the same manner, the control device 20 displays and outputs a still picture file (for example, a jpg file, a gif file or a png file) if it is still picture content. If it is document content, the control device 20 displays and outputs a document file (for example, a portable document format (PDF) file, a hyper text markup language (HTML) file or a file for presentation).

### 1. 2 Functional Configuration

### 1. 2. 1 Fuctional Configuratino of Management Server Device

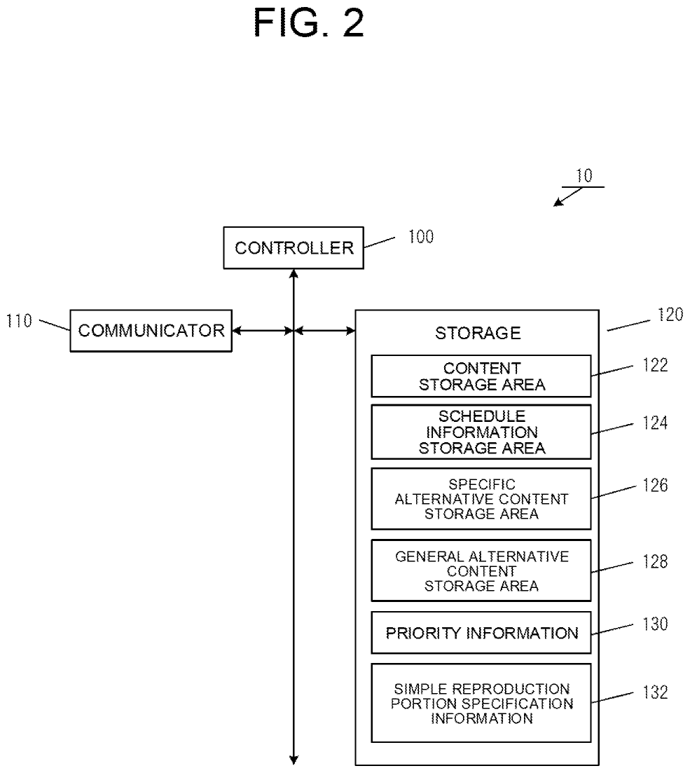

The functional configuration of the management server device 10 will be described with reference to FIG. 2. As shown in FIG. 2, the management server device 10 includes a controller 100, a communicator 110 and a storage 120.

The controller 100 is a functional portion for controlling the entirety of the management server device 10. The controller 100 includes one or a plurality of computing devices (for example, a central processing unit (CPU)) and implements various functions by reading and executing various programs.

The communicator 110 is a functional portion for the management server device 10 to communicate with an external device. For example, the communicator 110 is constituted by a network interface card (NIC) used in a wired/wireless LAN. The communication method may be Ethernet (registered trademark) or IEEE 802.11a/b/g/n.

The storage 120 is a function portion which stores various programs necessary for the operation of the management server device 10 and various types of data. The storage 120 includes, for example, a solid state drive (SSD) that is a semiconductor memory, a hard disk drive (HDD), and the like.

In the present embodiment, the storage 120 includes a content storage area 122, a schedule information storage area 124, a specific alternative content storage area 126 and a general alternative content storage area 128. The storage 120 further stores priority information 130 and simple reproduction portion specification information 132.

The content storage area 122 is an area for storing content to be transmitted (distributed) to the control device 20. The content storage area 122 may store a plurality of different content items. Each content is identified by a content name. The content name is information for identifying the content, and is represented by a character string such as “CM1” or “new product introduction”, or a serial number such as “001” or “002”.

The content name may be provided as an attribute for each content, or the storage 120 may store a table in which the content is associated with the content name. In case that a file is stored as content the content storage area 122, for example, a file including the content name in the file name may be stored.

One content may be composed of a plurality of files. In this case, the files may be stored in a folder whose content name is a folder name, or one or more files may be combined into one file (for example, archived in a ZIP format or CAB format), and the file name of the combined file may include the content name.

For example, when the content is identified by the file name, the base name of the file name (a portion of the file name excluding the extension) is referred to as the content name. At this time, the file having the file name “CM1.avi” can be identified as the content of “CM1”.

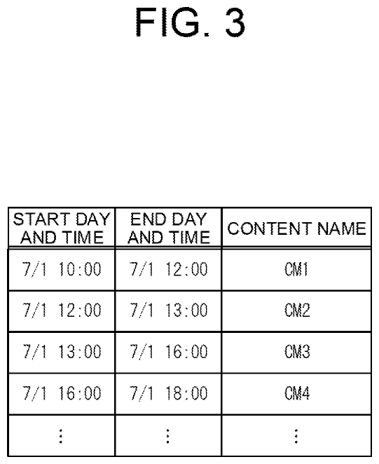

The schedule information storage area 124 is an area which stores schedule information that is a schedule of content output from the control device 20. FIG. 3 is a diagram showing an example of schedule information in the present embodiment. As shown in FIG. 3, the schedule information includes start date and time to start outputting content (for example, “7/1 10:00”) and end date and time to finish the output of the content (for example, “7/1 12:00”), and a content name (for example,“CM1”) for identifying the content to be output in the time at the start date and until the end date and time.

The specific alternative content storage area 126 and the general alternative content storage area 128 are areas for storing alternative content. The alternative content is content such as an advertisement reproduced by a simple reproduction portion 330 in the display device 30, when the control device 20 cannot control the display for the display device 30 because the load on the control device 20 is increased, etc. The simple reproduction portion 330 in the display device 30 is a functional portion that realizes the simple reproduction function. The simple reproduction portion 330 will be described in detail in the description of the functional configuration of the display device 30.

The specific alternative content storage area 126 is an area which stores specific alternative content (first alternative content) which is alternative content corresponding to specific content. The content stored in the specific alternative content storage area 126 is moving picture content or still picture content which can be displayed on display device 30, and is stored as, for example, a file.

The specific alternative content storage area 126 stores, for each specific alternative content, the content corresponding to the specific alternative content in an identifiable manner. For example, information of the content name of the content corresponding to the specific alternative content (hereinafter referred to as “corresponding content name”) may be included as an attribute or the storage 120 may store a table in which the corresponding content name is associated with the specific alternative content.

In storing a file in the specific alternative content storage area 126, the corresponding content name may be included in the file name or the folder name. For example, when the beginning to the hyphen of the file name is the corresponding content name, the file whose file name of the specific alternative content is “CM1-s.avi” can be identified as the specific alternative content of “CM1”.

The specific alternative content storage area 126 stores content by, for example, the following method.
(1) Copy content stored in the content storage area 122.
(2) Based on simple reproduction portion specification information 132 to be described later, convert the content stored in the content storage area 122 into content that can be reproduced by the simple reproduction portion 330 and store the converted content.
(3) Store specific alternative content prepared by an administrator or an advertiser.

For example, when the content to be converted is moving picture content, content conversion is performed by lowering the frame rate, lowering the bit rate or changing the format of the content (for example, re-encoding and changing the file format), or extracting a portion of the content. When the content to be converted is still picture content, the conversion is performed by changing the format or reducing the resolution of the content.

The conversion of content may be performed for each display device 30 which transmits the alternative content, and the converted content may be stored in the specific alternative content storage area 126 for each display device 30. For example, it is assumed that the frame rate of the moving picture content before the conversion is 30 frames/second, and the frame rate of the moving picture content which can be easily reproduced by the simple reproduction portion 330 in the display device 30 is up to 15 frames/second. In this case, the management server device 10 converts the frame rate of the moving picture content to 15 frames/sec, and stores as the specific alternative content storage area 126. Further, it is assumed that the frame rate of the moving picture content which can be easily reproduced by the simple reproduction portion 330 in the other display device 30 is 10 frames/sec. In this case, the management server device 10 converts the frame rate of the moving picture content into 10 frames/sec, and stores in the specific alternative content storage area 126. At this time, the converted two moving picture content items are stored as different moving picture content items. Then, in transmitting the specific alternative content to the display device 30, the management server device 10 transmits the moving picture content that can be output by the display device 30 of the transmission destination.

In a case that a plurality of display devices 30 are connected to the management server device 10, content may be converted into content that can be reproduced by the simple reproduction portion 330 having a standard capability and one alternative content may be stored in one content. Instead of converting the content to be reproduced by the simple reproduction portion 330 having the standard capability, the content may be converted into content which can be reproduced by the simple reproduction portion 330 having the lowest capability.

Also, the methods (1) to (3) described above may be combined. For example, the methods (1) and (2) may be combined. In this case, content that can be reproduced by the simple reproduction portion 330 can be used as the specific alternative content, and content that cannot be reproduced by the simple reproduction portion 330 can be used as the specific alternative content after the content is converted.

The general alternative content storage area 128 is an area which stores general alternative content (second alternative content) which is alternative content which can be displayed at an arbitrary timing. The general alternative content storage area 128 stores moving picture content and still picture content as the same as the specific alternative content storage area 126.

At least one content stored in the general alternative content storage area 128 may be content that can be displayed by any of the display devices 30 connected to the management server device 10. By this way, even when the specific alternative content cannot be displayed on the display device 30, the display device 30 can display the general alternative content. Therefore, it is possible to prevent an accident in which nothing is displayed on the display device 30. The content that can be displayed by any of the display devices 30 may be prepared by the administrator in advance, or the content stored in the general alternative content storage area 128 may be converted and then stored (overwritten).

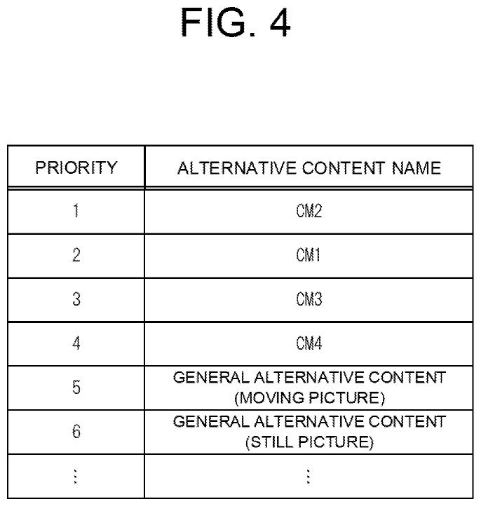

The priority information 130 is information for specifying the priority of the alternative content displayed by the display device 30, among the alternative content items transmitted to the display device 30. FIG. 4 is a diagram showing an example of priority information in the present embodiment. As shown in FIG. 4, as the priority information, the priority (for example, “1”) and the alternative content name (for example, “CM2”) for specifying the alternative content to be displayed are stored.

The alternative content name is information capable of specifying alternative content of any of the specific alternative content and the general alternative content. In the present embodiment, in specifying the specific alternative content, it is assumed that the corresponding content name is stored. For example, when an alternative content name is “CM2”, the specific alternative content having the corresponding content name of “CM2”, that is,the specific alternative content corresponding to “CM2” is specified. In addition, in specifying general alternative content of a moving picture, “general alternative content (moving picture)” is used, and in specifying general content of a still picture, “general alternative content (still picture)” is used.

If one or a plurality of alternative content items can be specified, the alternative content name other than the above may be stored. For example, a plurality of corresponding content names may be designated such as “CM1 or CM3”, or one or more file names of the alternative content may be specified. When a plurality of alternative content names are stored as alternative content name, it indicates that the priorities of the alternative content items are the same. Then, the display device 30 can select alternative content to be displayed from among alternative content items having the same priority. For example, the display device 30 sequentially displays alternative content items having the same priority. Specifically, when the alternative content name is stored as “CM1 or CM3” the display device 30 sequentially displays the specific alternative content corresponding to “CM1” and the specific alternative content corresponding to “CM3”. The display device 30 may select and display one content selected from alternative content items having the same priority. When the alternative content items having the same priority are specific alternative content and short moving pictures or the like, the display device 30 can display the specific alternative content a plurality of times. At this time, the display device 30 may display the specific alternative content corresponding to the content to be displayed in the time zone close to the current time based on the current time and the schedule information, each time the alternative content is displayed.

If the priority of alternative content can be specified, it is not necessary to express the priority information 130 in the format as shown in FIG. 4. For example, the priority information 130 may store information to which a score calculated by a predetermined method is given for each alternative content. The priority may be determined based on an alternative content attribute, and it is acceptable to store information related to an attribute for raising the priority or an attribute for lowering the priority as the priority information 130. In this way, when the priority is not directly stored in the priority information 130, the display device 30 determines the priority based on the priority information 130, and then displays the alternative content.

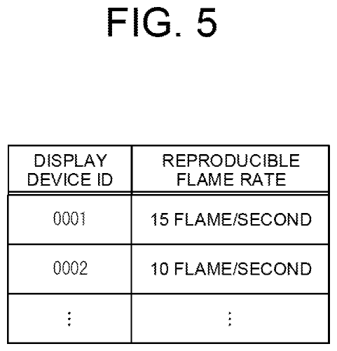

The simple reproduction portion specification information 132 is information indicating the specification of the simple reproduction portion 330 in the display device 30 for each display device 30 connected to the management server device 10. FIG. 5 is a diagram showing an example of the simple reproduction portion specification information in the present embodiment. As shown in FIG. 5, stored are, as simple reproduction portion specification information, a display device ID (for example, “0001”) for identifying the display device 30 and a reproducible frame rate (for example, “15 frames/second”) indicating an upper limit of a frame rate of a moving picture reproducible by the simple reproduction portion 330 as the specification of the simple reproduction portion 330. As the specification of the simple reproduction portion 330, the format of the reproducible content, the reproducible bit rate, the upper limit size of the reproducible content, and the like may be stored.

The storage 120 may include display information related to the display of content. For example, when a plurality of content items are associated with one content name, the display time for each content may be stored as the display information. In a case of dividing the display area of a display 350 on the display device 30 into a plurality of areas and displaying content in each area, a list in which the area information and the content names are recited may be stored as the display information. When the display area is a rectangular area, the storage 120 stores a CSV file in which two coordinates that are diagonals of the rectangular area and the content name of the content to be displayed in the area are separated by commas. The file name of the CSV file may be stored as the content name of the schedule information, and a plurality of content items may be displayed based on the display information.

### 1. 2. 2 Functional Configuration of Control Device

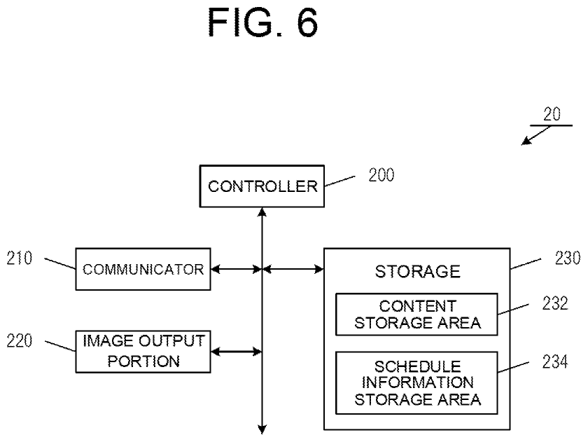

The functional configuration of the control device 20 will be described with reference to FIG. 6. As shown in FIG. 6, the control device 20 includes a controller 200, a communicator 210, an image output portion 220, and a storage 230.

The controller 200 is a functional portion which controls the whole of the control device 20. The controller 200 includes one or a plurality of computing devices (for example, CPU), and realizes various functions by reading and executing various programs.

The communicator 210 is a functional portion for the control device 20 to communicate with an external device. For example, the communicator 210 is constituted by a NIC used in a wired/wireless LAN. The communication system may be Ethernet (registered trademark) or IEEE802.11a/b/g/n.

The image output portion 220 is a functional portion that outputs an image signal of content stored in a content storage area 232 to be described later to the display device 30. The image output portion 220 is configured as a terminal, for example, and is connected by any means such as HDMI (registered trademark), display port and universal serial bus (USB) type C. Also, for example, in a case of connecting by composite, the image signal and the audio signal may be connected separately.

The storage 230 is a function portion which stores various programs necessary for the operation of the control device 20 and various kinds of data. The storage 230 includes, for example, an SSD which is a semiconductor memory, an HDD, and the like.

In the present embodiment, the storage 230 includes the content storage area 232 and a schedule information storage area 234. The content storage area 232 is an area for storing content transmitted from the management server device 10. The schedule information storage area 234 is an area for storing schedule information transmitted from the management server device 10.

The management server device 10 may transmit a portion of the content stored in the content storage area 122 to the control device 20. Also, the management, server device 10 may transmit a portion of the schedule information stored in the schedule information storage area 124 to the control device 20. For example, when content is periodically transmitted on a daily basis, the content and the schedule information for one day are transmitted to the control device 20.

### 1. 2. 3 Functional Configuration of Display Device

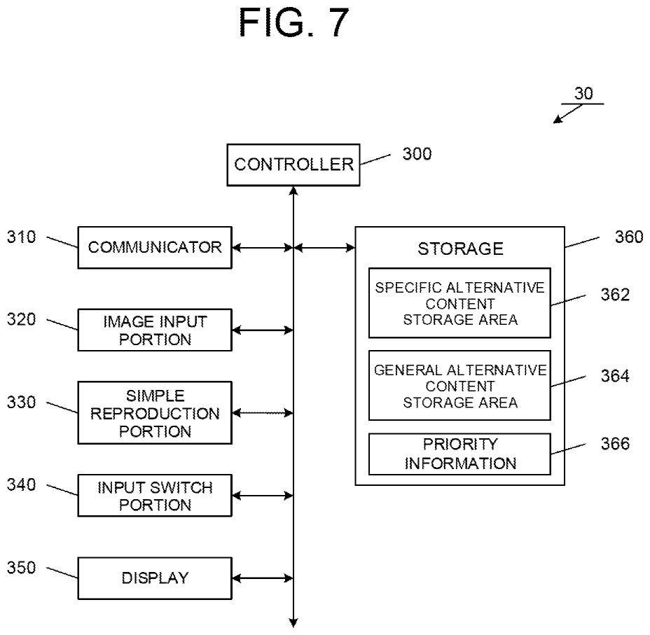

The functional configuration of the display device 30 will be described with reference to FIG. 7. As shown in FIG. 7, the display device 30 includes a controller 300, a communicator 310, an image input portion 320, a simple reproduction portion 330, an input switch portion 340, a display 350 and a storage 360.

The controller 300 is a functional portion which controls the whole of the display device 30. The controller 300 includes one or a plurality of computing devices (for example, CPU), and realizes various functions by reading and executing various programs.

The communicator 310 is a functional portion for the display device 30 to communicate with an external device. For example, the communicator 310 is constituted by a NIC used in a wired/wireless LAN. The communication system may be Ethernet or IEEE802.11a/b/g/n.

The image input portion 320 is a functional portion that receives the image signal output from the image output portion 220 of the control device 20. The image input portion 320 is configured as, for example, a terminal, and is connected to the image output portion 220 and the image input portion 320.

The simple reproduction portion 330 is a functional portion that reads out alternative content stored in a specific alternative content storage area 362 and a general alternative content storage area 364, which will be described later, and outputs an image signal based on the read alternative content to the input switch portion 340. For convenience of description, even when still picture data is displayed by the simple reproduction portion 330, it is assumed that the simple reproduction portion 330 reproduces the still picture data.

The simple reproduction portion 330 may be a simple reproduction function previously provided in the display device 30, or may be a reproduction function expanded to the display device 30. In the case of the extension, the simple reproduction portion 330 may be realized by a simple reproduction device on which a dedicated expansion board is mounted or connected to HDMI (registered trademark) or USB, for example. The simple reproduction device may be a device m which a reproduction function is implemented on a device equipped with an operating system such as Android, iOS, Windows Embedded, or TRON, or a device in which an application of a dedicated reproduction function is incorporated.

By connecting a storage medium such as a USB memory or a SD card in which content is stored to the simple reproduction portion 330, the simple reproduction portion 330 can output content in the connected storage medium.

Here, the simple reproduction indicates that the operation and the function in the reproduction are limited inn comparison with the normal reproduction of the content. For example, the simple reproduction is a function capable of reproducing content having a small capacity or content having a low bit rate or a low frame rate compared to the reproduction of ordinary content. The reproducible format may also be limited as compared to normal.

Although the embodiments are described as the simple reproduction, with future technological innovation and cost reduction, it is apparent that the equivalent of the normal reproduction function (that is, content of the same data size or the same bit rate as regular content) may be provided.

The input switch portion 340 is a functional portion that inputs an image signal output from the image input portion 320 and the simple reproduction portion 330, and switches the image signal to be output to the display 350. The display 350 outputs either the content output from the control device 20 or the alternative content to be simply reproduced by the display device 30.

The display 350 is a functional portion which outputs an image based on the content and the alternative content. For example, the display 350 includes a display device such as a liquid crystal display (LCD) and an organic EL (OLED) display, an illumination device such as a projector, and the like.

The storage 360 is a function portion which stores various programs necessary for the operation of the display device 30 and various kinds of data. The storage 360 includes, for example, an SSD which is a semiconductor memory, an HDD, and the like.

In the embodiment, the storage 360 includes the specific alternative content storage area 362 and the general alternative content storage area 364, and stores priority information 366.

The specific alternative content storage area 362 is an area for storing the specific alternative content transmitted from the management server device 10. The general alternative content storage area 364 is an area for storing the general alternative content transmitted from the management server device 10. The priority information 130 transmitted from the management server device 10 is stored as the priority information 366.

### 1. 3 Process Flow

Next, processing in the embodiment will be described with reference to drawings. The sequence and the operation flow described in the present embodiment are an example, and it is apparent that the order of processing may be reversed, or some processing may be performed simultaneously, as long as there is no influence of the operation.

### 1. 3. 1 Outline of Processing

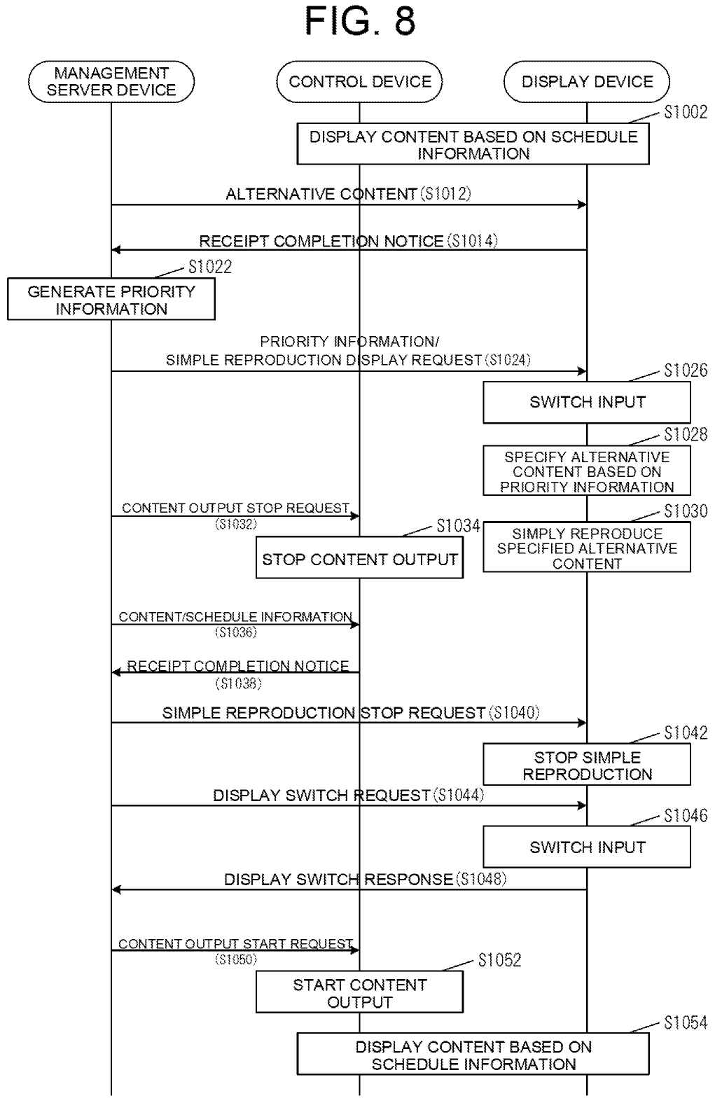

The outline of the process of the present embodiment will be described with reference to FIG. 8. FIG. 8 is a sequence diagram for explaining the overall processing flow of the management server device 10, the control device 20 and the display device 30.

The control device 20 outputs an image signal of content based on the schedule information, and the display device 30 displays the content, thereby displaying the content based on the schedule information (S1002).

In this state, the management sewer device 10 transmits in advance the specific alternative content and the general alternative content which are the alternative content to the display device 30 (S1012). The display device 30 stores the received specific alternative content in the specific alternative content storage area 362 and the received general alternative content in the general alternative content storage area 364. When the reception of the alternative content transmitted from the management server device 10 is completed, the display device 30 transmits a reception completion notice to the management server device (S1014). The reception completion notice is a notice indicating that the content or the like transmitted from the management server device 10 has been properly received. The management server device 10 can detect that the alternative content has been successfully transmitted to the display device 30 by receiving the reception completion notice transmitted from the display device 30.

The management server device 10 may transmit to the display device 30 only the alternative content that can be reproduced by the simple reproduction portion 330 among the alternative content items with reference to the simple reproduction portion specification information 132. By doing so, it is possible to suppress an increase in network traffic and to avoid an extra load from being applied to the display device 30.

Subsequently, when it is time to transmit content to the control device 20, the management server device 10 generates the priority information and stores it as the priority information 130 (S1022). Then, the management server device 10 transmits a simple reproduction display request including the priority information 130 to the display device 30 (S1024). The simple reproduction display request is a request for causing the display device 30 to start outputting the alternative content by the simple reproduction portion 330. The display device 30 receives the simple reproduction display request including the priority information 130, and stores the received priority information 130 as the priority information 366.

Subsequently, the display device 30 switches the image signal to be output to the display 350 by the input switch portion 340 so as to perform display based on the image signal output from the simple reproduction portion 330 (S1026). Then, the display device 30 specifies the alternative content to be simply reproduced based on the priority information 366 (S1028), and simply reproduces the specified alternative content at the simple reproduction portion 330 (S1030).

When the alternative content is simply reproduced by the display device 30, the management server device 10 transmits the content and the schedule information to the control device 20. The management server device 10 transmits a content output stop request to the control device 20 (S1032). The content output stop request is a request to stop outputting the image signal of the content from the image output portion 220. The control device 20 that has received the content output stop request stops outputting the content (S1034).

Then, the management server device 10 transmits the schedule information and the content to the control device 20 (S1036). The control. device 20 stores the content received from the management server device 10 in the content storage area 122. The schedule information received from the management server device 10 is stored in the schedule information storage area 124.

When the reception of the content and the schedule information. transmitted from the management server device 10 is completed, the control device 20 transmits a reception completion notice to the management server device 10 (S1038). The management server device 10 can detect that the content and the schedule information have been properly transmitted to the control device 20 by receiving the reception completion notice transmitted from the control device 20.

Subsequently, the management server device 10 transmits a simple reproduction stop request to the display device 30 (S1040). The simple reproduction stop request is a request for stopping the output of the alternative content by the simple reproduction portion 330 to the display device 30. The display device 30 stops the reproduction of the alternative content by the simple reproduction portion 330 based on the reception of the simple reproduction stop request (S1042).

Also, the management server device 10 transmits display switch request to the display device 30 (S1044). The display device 30 switches the image signal to be output to the display 350 by the input switch portion 340 so as to perform the display based on the image signal output from the control device 20 responsive to the reception of the display switch request (S1046). Then, the display device 30 transmits a display switch response to the management server device 10 (S1048).

The management server device 10 transmits a content output start request to the control device 20 (S1050). The content output start request is a request to start outputting the image signal of the content based on the schedule information. By this way, the control device 20 starts outputting the image signal of the content (S1052), and the content is displayed by the display device 30 (S1054).

The display switch request, the simple reproduction display request, the simple reproduction stop request, the content output start request, and the content output stop request may be performed by executing a command or transmitting an internet protocol (IP) packet including predetermined data, and any other methods as long as the request can be transmitted. Any method may be used for the display switch response and the reception completion notice as long as the response and the notice can be appropriately transmitted.

### 1. 3. 2 Flow of Processing of Management Server Device

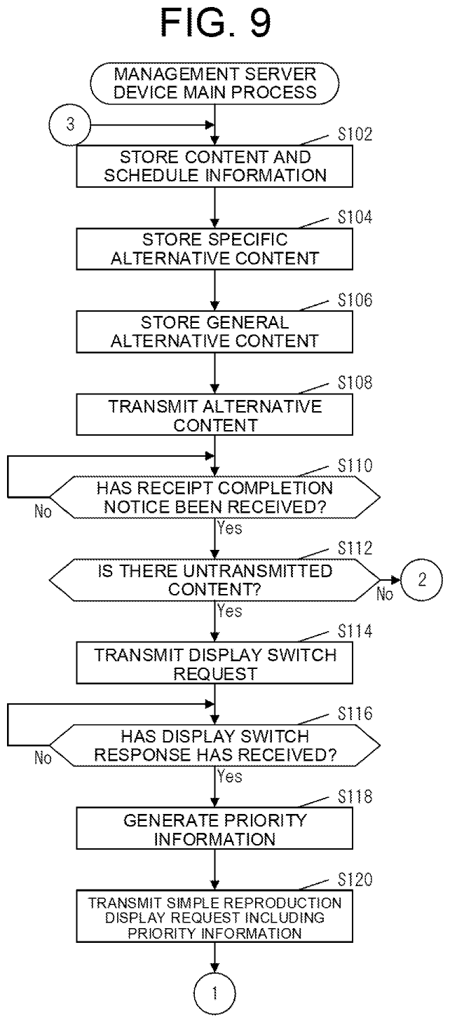

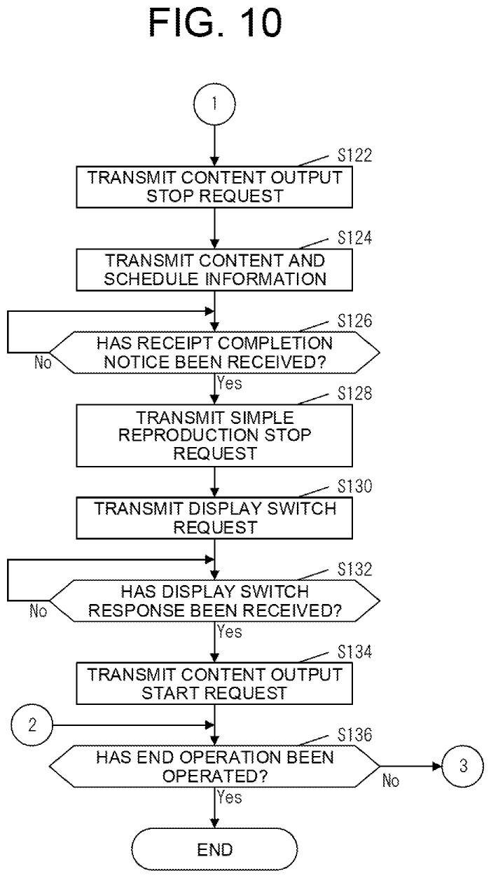

The flow of the main processing of the management server device 10 will be described with reference to FIGS. 9 and 10. The controller 100 stores content and schedule information (step S102). Specifically for example, the administrator of the signage system stores the content entered from the advertiser or the like in the content storage area 122, and stores the schedule information created by the administrator in the schedule information storage area 124.

Subsequently, the controller 100 stores the specific alternative content (step S104). As described above, the specific alternative content may be stored in the specific alternative content storage area 126 by copying or converting the content stored in the content storage area 122, or the content prepared by the administrator or the advertiser may be stored in the specific alternative content storage area 126.

Then, the controller 100 stores the general alternative content (step S106). The general alternative content is stored by storing the content prepared by the administrator or the advertiser in the general alternative content storage area 128.

Subsequently,the controller 100 transmits, to the display device 30, the specific alternative content and general alternative content, which are the alternative content (step S108). Then, the controller 100 determines whether the reception completion notice has been received from the display device 30 (step S110). If the reception completion notice has been received, the process moves to step S112 (step S110; Yes). If the reception completion notice is not received, the determination in step S110 is continued until the reception completion notice is received (step S110; No). At this time, in case that the alternative content transmission completion notice is not received within a predetermined time, the transmission of the alternative content may be performed again to the display device 30.

Subsequently, the controller 100 determines whether there is any content that has not been transmitted to the control device 20 among the content items stored in the content storage area 122 (step S112). If there is transmitted content, the management server device 10 transmits a display switch request to the display device 30 (step S112; Yes to step S114). Then, the controller 100 determines whether the display switch response has been received from the display device 30 (step S116). In step S116, the controller 100 can detect that the display device 30 is displaying the content output from the control device 20 by receiving the display switch response from the display device 30 (step S116; Yes).

The process in step S112 may be executed each time content is stored, or may be periodically executed such as a specific time of day and a time determined once monthly. When it is necessary to transmit content urgently, it may be executed by the instruction of the administrator.

Step S116 is repeated until the display switch response transmitted from the display device 30 is received (step S116; No). However, when the display switch response cannot be received within a predetermined time, the main processing may be ended, and the transmission of the content may be stopped. In this case, the main processing may be performed again at another timing.

When the display switch response is received from the display device 30, the controller 100 subsequently generates priority information (step S116; Yes to step S118).

The priority for the alternative content is determined in the order described below, for example.

(1) Content that control device 20 was planning to output at the transmission of content:

As already described in FIG. 8, when the management server device 10 transmits content to the control device 20, the control device 20 is in a state of stopping the output of the content (S1034). Therefore, the content supposed to be output is not output from the control device 20. To cope with this, it is desirable that the alternative content is content that should be originally output.

Therefore, the controller 100 reads the schedule information from the schedule information storage area 124, and specifies the output content at the time when the content is transmitted to the control device 20. Then, the controller 100 sets the alternative content corresponding to the output content at the time at which the content is transmitted as alternative content having the highest priority.

(2) Content output by the control device 20 in the time zone before and after the transmission of content:

The controller 100 reads the schedule information from the schedule information storage area 124, and specifies the output content in the time zone before and after the time when the content is transmitted to the control device 20. Then, the controller 100 sets the specific alternative content corresponding to the specified output content as alternative content having the next highest priority,

In general, digital signage outputs content with the most advertising effect in that time zone. Accordingly, even when the specific alternative content having the highest priority cannot be output, a considerable advertisement effect can be expected by outputting the specific alternative content corresponding to the content output in the adjacent time zone.

The range to be referred to as the adjacent time zone may be limited. For example, the priority may be determined for the output content in the time zone within three hours before and after the time at which the content is transmitted, or the priority may be determined for the output content in the two time zones before and after the time zone in which the content is transmitted. By this way, by limiting the range in which the priority is determined, it is possible to prevent the output of the alternative content corresponding to the content whose advertisement effect cannot be expected much. The range of time zones to be referred to as the vicinity may be set by the management server device 10 in advance or by the administrator.

(3) General alternative content:

When it is impossible to specify a clear alternative content based on the schedule information stored in the schedule information storage area 124, the general alternative content is set as the alternative content having the next highest priority.

When the priority of the alternative content is determined in the order of (1) to (3) described above, the controller 100 stores the priority and the name of the alternative content as the priority information 130. Then, the controller 100 transmits the simple reproduction display request including the priority information 130 to the display device 30 (step S120).

Moving to FIG. 10, the controller 100 transmits the content output stop request to the control device 20 (step S122), and further transmits the content and the schedule information to the control device 20 (step S124).

Subsequently, when the controller 100 receives the reception completion notice from the control device 20 (step S126; Yes), the controller 100 transmits the simple reproduction stop request and the display switch request to the display device 30 (step S128 to Step S130).

When the display switch response is received from the display device 30, the management server device 10 transmits e content output start request to the control device 20, and requests the control device 20 to start the output of the content. (Step S132; Yes to Step S134). By this way, the display device 30 can perform display based on the image signal output from the control device 20).

Subsequently, the controller 100 determines whether the end operation has been performed (step S136). The end operation may be an operation of turning off the power supply or an operation of terminating the main processing. If such an operation has been performed, the present process ends (step S136; Yes). If the end operation has not been performed, the process returns to step S102 (step S136; No to step S102).

### 1. 3. 3 Flow of Processing in Controller

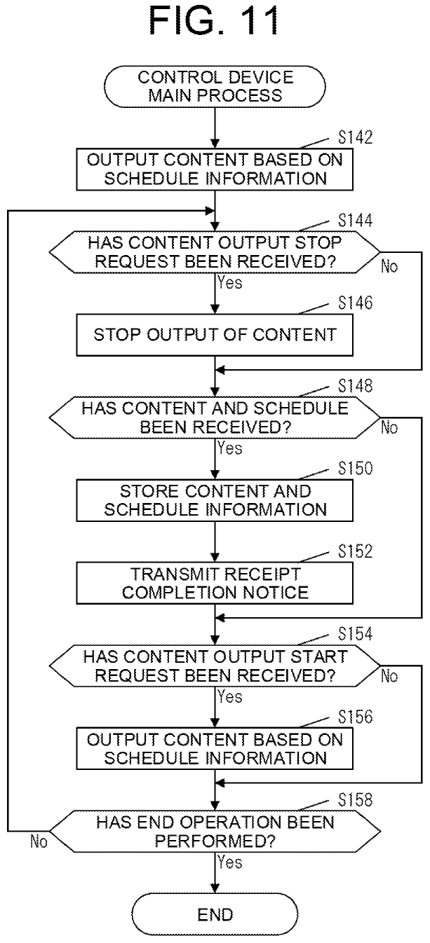

The flow of main processing of control device 20 will now be described with reference to FIG. 11. The control device 20 outputs the content based on the schedule information (step S142). The controller 200 reads the schedule information, and specifies the content to be output at the current time. The controller 200 reads out the specified content and outputs the image signal of the content from the image output portion 220. By doing so, it is possible to display and control the content on the display device 30 along with the schedule information.

Subsequently, the controller 200 determines whether the content output stop request has received from the management server device 10 (step S144). When the content output stop request is received, the output of the content is stopped (step S144; Yes to step S146). The controller 200 stops a process to output an image signal based on the read content from the image output portion 220. Alternatively; the controller 200 stops a process to read the schedule information stored in the schedule information storage area 234. As a result, the output of the content is stopped.

Then, the controller 200 determines whether the content and the schedule information have been received from the management server device 10 (step S148). When the controller 200 receives the content and the schedule=, information from the management server device 10, the controller 200 stores the received content in the content storage area 232, and stores the received schedule information in the schedule information storage area. 234 (step S150). When the storage of the content is completed, the controller 200 transmits the reception completion notice to the management server device 10 (step S152).

Then, the controller 200 determines whether the content output start request has been received from the management server device 10 (step S154). When the content output start request is received, the output of the content is started (step S154; Yes to step S156). The content may be output in the same manner as in step S142.

Subsequently, it is determined whether the end operation has been performed (step S158). The end operation is an operation of turning off the power supply, or an operation of terminating the main processing. If such an operation has been performed, the main processing ends (step S158; Yes). If the end operation has not been performed, the process returns to step S144 (step S158; No to step S144).)

### 1. 3. 4 Flow of Processing in Display Device

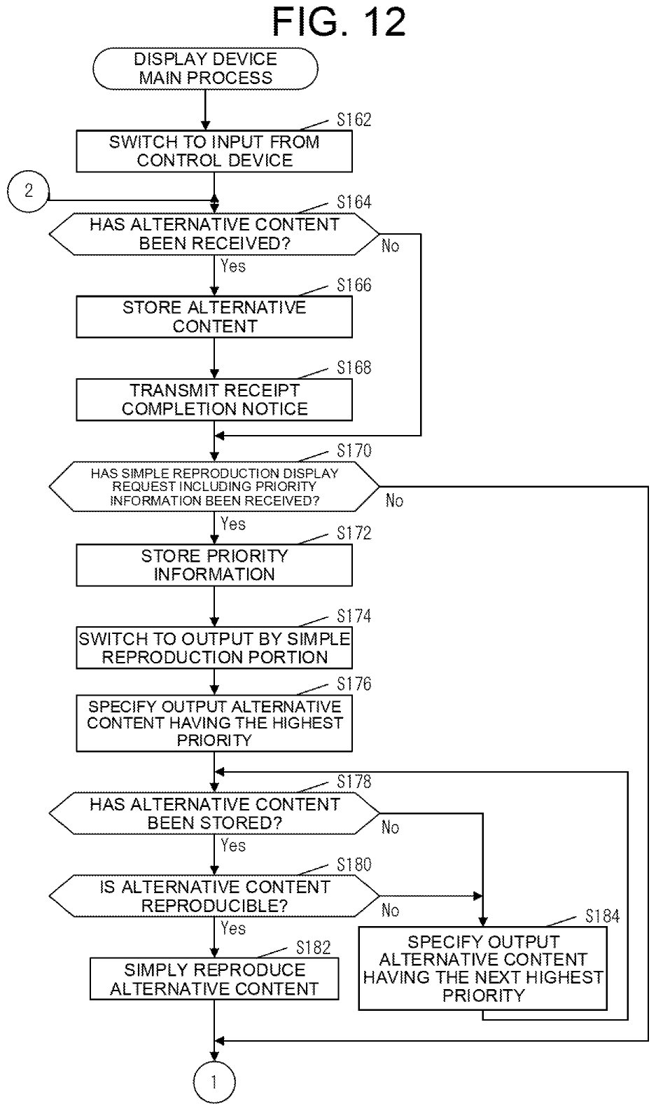

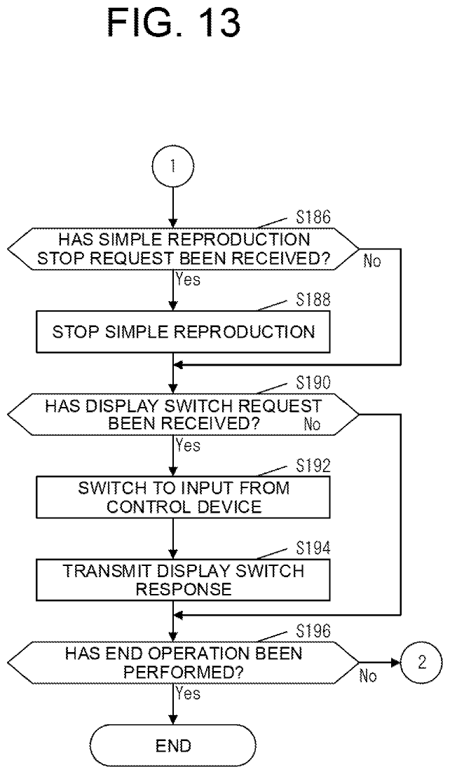

The main processing flow of the display device 30 will be described with reference to FIG. 12 and FIG. 13. The input switch portion 340 switches an image signal to be output to the display 350 to an image signal based on the content input from the control device 20 via the image input portion 320 (step S162).

Subsequently, the controller 300 determines whether the alternative content has been received from the management server device 10 (step S164). When the controller 300 receives the alternative content from the management server device 10, the controller 300 stores the received specific alternative content storage area 126 in the specific alternative content storage area 362, and stores the general alternative content in the general alternative content storage area 364 (Step S164; Yes to Step S166). When the reception of the alternative content is completed, the controller 300 transmits the reception completion notice to the management server device 10 (step S168).

Then, the controller 300 determines whether the simple reproduction display request including the priority information 130 transmitted from the management server device 10 has been received (step S170). When the simple reproduction display request including the priority information 130 is received from the management server device 10, the controller 300 stores the received priority information 130 as the priority information 366 (step S170; Yes to step S172). Then, the input switch portion 340 switches the image signal to be output to the display 350 to the image signal output from the simple reproduction portion 330 (step S174).

Subsequently, the controller 300 identifies the alternative content having the highest priority from the priority information 366 (step S176). When the priority and the alternative content name are stored in the priority information 366, the alternative content is specified based on the alternative content name whose priority is “1”. If the priority information 366 is score or attribute information, the controller 300 calculates the priority of the alternative content based on the score and the attribute information, and specifies the alternative content having the highest priority.

Then, the controller 300 determines whether the specified alternative content has been stored in the specific alternative content storage area 362 or the general alternative content storage area 364 (step S178). When the specified alternative content is stored, the simple reproduction portion 330 determines whether the alternative content can be reproduced (step S178; No to step S180). When the alternative content is reproducible, the simple reproduction portion 330 simply reproduces the alternative content (step S180; Yes to step S182). By this way, the alternative content is displayed om the display 350. When there are a plurality of alternative content items, the alternative content items may be simply reproduced in the order, or some m the alternative content items may be simply reproduced.

When alternative content is not stored in the specific alternative content storage area 362 and the general alternative content storage area 364 (Step S178; No), or cannot be reproduced by the simple reproduction portion 330 (Step S 180; No), the controller 300 identifies the output alternative content having the next highest priority, and then returns to step S178 (step S184 to step S178).

The case where alternative content is not stored in the specific alternative content storage area 362 and the general alternative content storage area 364 is a case where alternative content is not transmitted from the management server device 10. As a specific example, there is a case where the management server device 10 does not transmit alternative content which cannot be reproduced by the simple reproduction portion 330, or a case where alternative content is not stored in the management server device 10.

The case where the reproduction cannot be performed by the simple reproduction portion 330 is a case where alternative content is stored but the reproduction cannot be performed by the simple reproduction portion 330. As a specific example, there is a case where the management server device 10 converts content to generate alternative content, but the generated alternative content cannot be reproduced by the simple reproduction portion 330.

Moving to FIG. 13, then, when the controller 300 receives the simple reproduction stop request from the management server device 10, the controller 300 performs a control to stop outputting the alternative content by the simple reproduction portion 330 (step S186; Yes to Step S188).

Subsequently, the controller 300 determines whether the display switch request has been received from the management server device 10 (step S190). When the display switch request is received from the management server device 10, the input switch portion 340 switches the image signal to be output to the display 350 to an image signal based on the content input from the control device 20 via the image input portion 320 (step S191; Yes to step S192). The controller 300 transmits the display switch response to the management server device 10 (step S194).

Subsequently, the controller 300 determines whether the end operation has been performed (step S196). The end operation may be an operation of turning off the power supply or an operation of terminating the main processing. When such an operation is performed, the main processing is terminated (step S196; Yes). When the end operation is not performed, the process returns to step S16 (step S196; No to step S164).

### 1. 4 Operation Example

An example of the operation of the present embodiment will he described with reference to the drawings. In the description of the operation example, the content is stored as a file, and is assumed to be identified by the file name. The specific alternative content is stored as a file, and it is assumed that the corresponding content name is from the beginning to the hyphen of the file name.

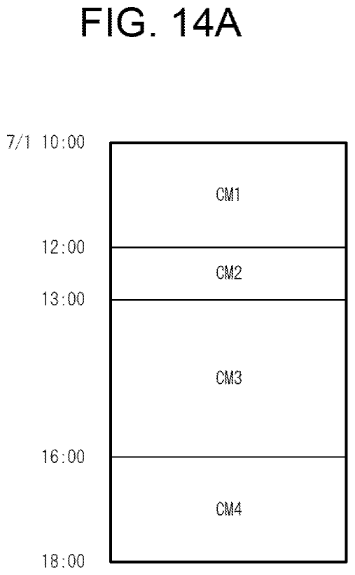

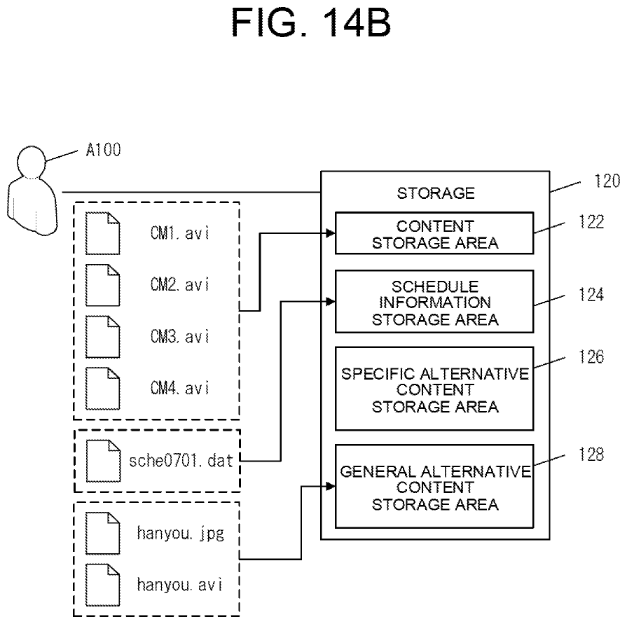

FIG. 14A is a diagram showing an example of content schedule information. FIG. 14A shows outputting the content of “CM1” in the time zone of 10:00 to 12:00, the content of “CM2” in the time zone of 12:00 to 13:00, the content of “CM3” in the time zone of 13:00-16:00, and the content of “CM4” in the time zone of 16:00-18:00, on July 1.

FIG. 14B is a diagram showing a file that an administrator A100 stores in the management server device 10. The administrator A100 prepares, as shown in FIG. 14A, a file describing schedule information (“sche0701.dat”), content (“CM1.avi”, “CM2.avi”, “CM3.avi”, “CM4.avi”) and general alternative content (“hanyou.jpg”, “hanyou.avi”), and stores the file and the content items in the management server device 10. At this time, the content items are stored in the content storage area 122, the schedule information is stored in the schedule information storage area 124, and the general alternative content is stored in the general alternative content storage area 128.

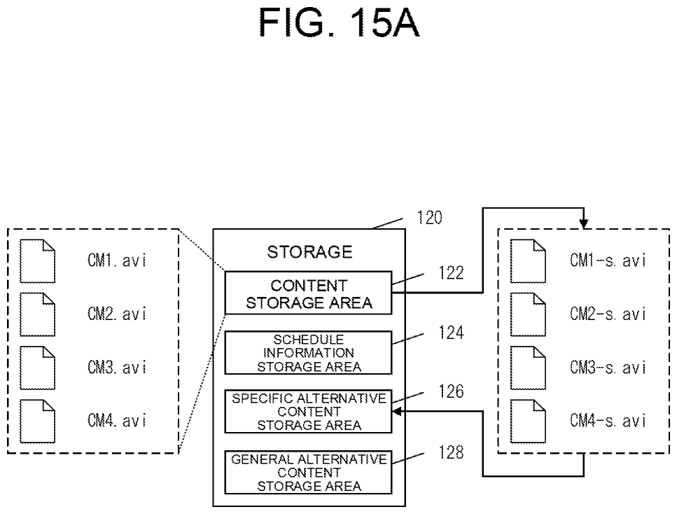

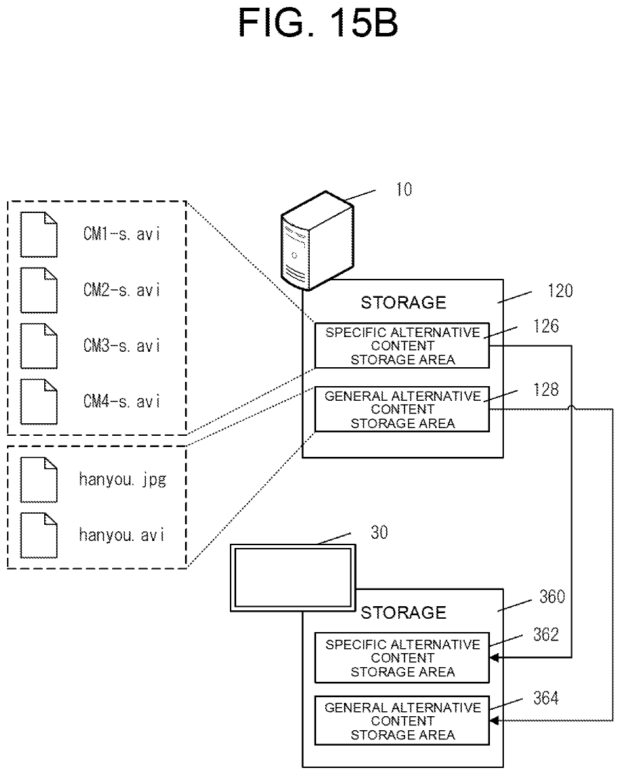

FIG. 15A is a diagram showing that the management server device 10 converts a display file corresponding to the content and stores the converted file as the specific alternative content storage area 126. As shown in FIG. 15A, regarding “CM1avi”, “CM2.avi”, “CM3.avi” and “CM4.avi” stored in the content storage area 122, the management server device 10 converts each file into content playable by the display device 30. Then, the management server device 10 stores the converted files as “CM1-s.avi”, “CM2-s.avi”, “CM3-s.avi” and “CM4-s.avi” in the specific alternative content storage area 126. Thus, since the management server device 10 converts the files, it is not necessary for the administrator A100 to separately prepare specific general alternative content. Further, the specific alternative content is associated with the content according to the file name. For example, the specific alternative content having the file name of “CM1-s.avi” can be identified as the specific alternative content corresponding to the content of “CM1”.

Then, as shown in FIG. 15A, when the management server device 10 transmits the alternative content to the display device 30, the display device 30 stores the specific alternative content and the general alternative content.

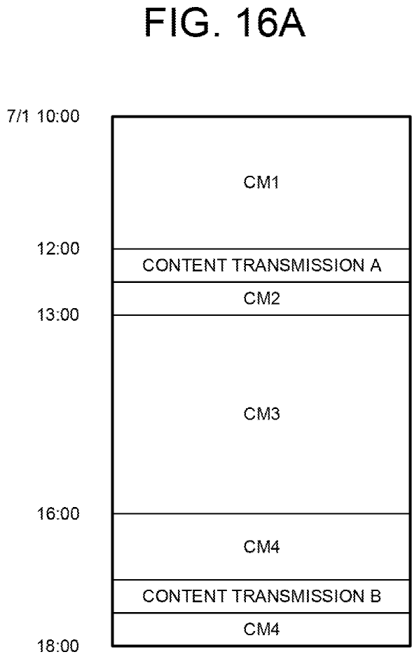

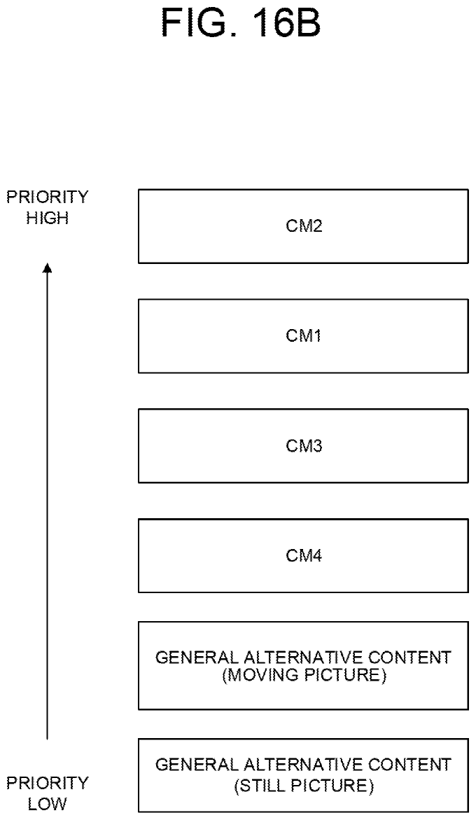

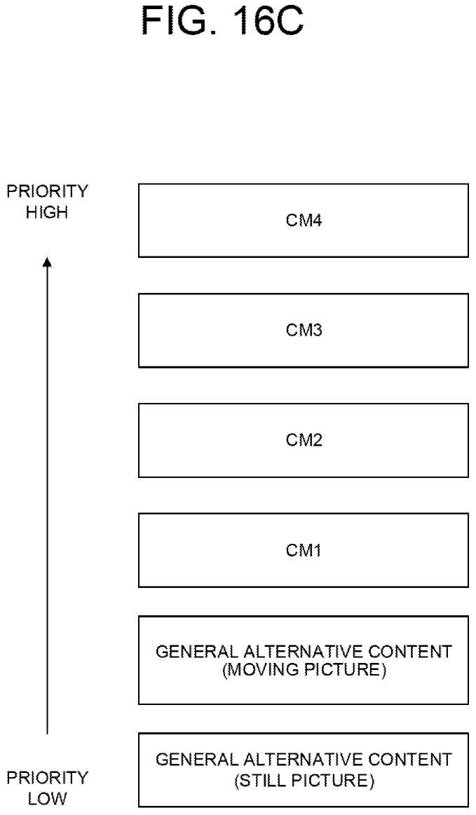

FIG. 16A shows a schedule when the management server device 10 transmits content in time zones in which the control device 20 and the display device 30 output “CM2” and “CM4”. The figure shows, among content transmission timings the transmission of content in the time zone in which “CM2” is output as “content transmission A” and the transmission of content in the time zone in which “CM4” is output as “content transmission B”. Essentially, it is not desirable to transmit content during the output of the content. However, in a case of transmitting content urgently or using digital signage in a store which is open 24 hours a day, the content is transmitted during the output of content.

FIG. 16B shows the priority of output alternative content items in the content transmission A. As shown in FIG. 16B, it is desirable to output the specific alternative content corresponding to “CM2” as alternative content in order to output alternative content in the time zone when “CM2” is output by right. Therefore, as the output alternative content, the priority of the specific alternative content corresponding to “CM2” is the highest.

Next, the management server device 10 increases the priority of the specific alternative content corresponding to the content output in the time zone near the time zone in which the content transmission A is performed. The management server device 10 sets a high priority in the order of the specific alternative content corresponding to “CM1”, the specific alternative content corresponding to “CM3”, and the specific alternative content corresponding to “CM4” in accordance with the time zone close to the timing of the content transmission A. Then, the management server device 10 also determines the priority for general moving picture content which is a moving picture which may be output at any time and general still picture content which is a still picture which may be output at any time.

The management server device 10 determines the priority as described above, and stores the determined priority as the priority information 130. Then, the simple reproduction display request including the priority information 130 is transmitted to the display device 30.

The display device 30 stores the priority information 130 received from the management server device 10 as the priority information 366. Then, the output alternative content is specified from the higher priority. In the example of FIG. 16B, the output alternative content with the highest priority is the specific alternative content corresponding to “CM2.” Therefore, the display device 30 reads “CM2-s.avi”, which is the specific alternative content corresponding to “CM2”, from the specific alternative content storage area 362, and reproduces “CM2-s.avi”.

As described above, when the special alternative content corresponding to “CM2” (“CM2-s.avi” in the present operation example) cannot be reproduced by the simple reproduction portion 330, the specific alternative content corresponding to “CM1” is output. In addition, when the specific alternative content corresponding to “CM1” cannot be reproduced by the simple reproduction portion 330, the alternative content to be output along the priority is determined so as to output the specific alternative content corresponding to “CM3”. By determining the priority as described above, it becomes possible to preferentially output the alternative content having a high advertisement effect in the time zone in which the content transmission A is performed.

FIG. 16C shows the priority of the output alternative content items in content transmission B. Also in this case, the priority of “CM4”, which is originally outputted content, is the highest. Then, the priority is high in the order of “CM3”, “CM2”, “CM1”, which are content items to be output in the vicinity tune zone, general moving picture content which may be output at any time and general still picture content which may be output at any time.

It should be noted that how long does it take to transmit the content depends on the amount of content to be transmitted to the control device 20 by the management server device 10, the state of the management server device 10 or control device 20, and the state of the network NW. Therefore, the reproduction of the alternative content by the simple reproduction portion 330 may be time-adjusted. For example, when the alternative content to be output is a moving picture having a short reproduction time, the time-adjustment may be performed by inserting general still picture content after the reproduction end of the moving picture. Alternatively, the moving picture may be repeatedly reproduced.

According to the embodiment, when the management server device transmits content to the control device 20, alternative content which is alternative for the content to be originally output is output by the display device 30. Since the alternative content output by the display device 30 is specified based on the priority based on the schedule information, the advertisement effect is high and alternative content suitable as digital signage can be output.

### 2. SECOND EMBODIMENT

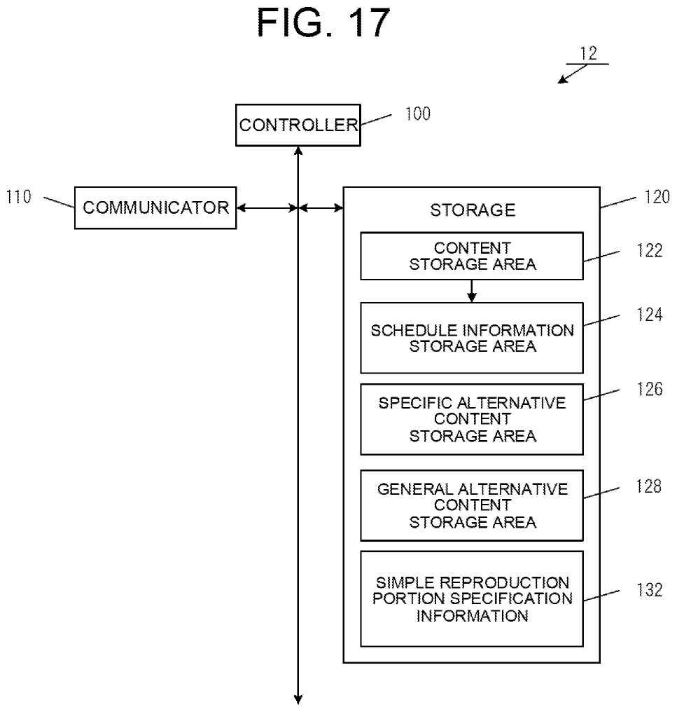

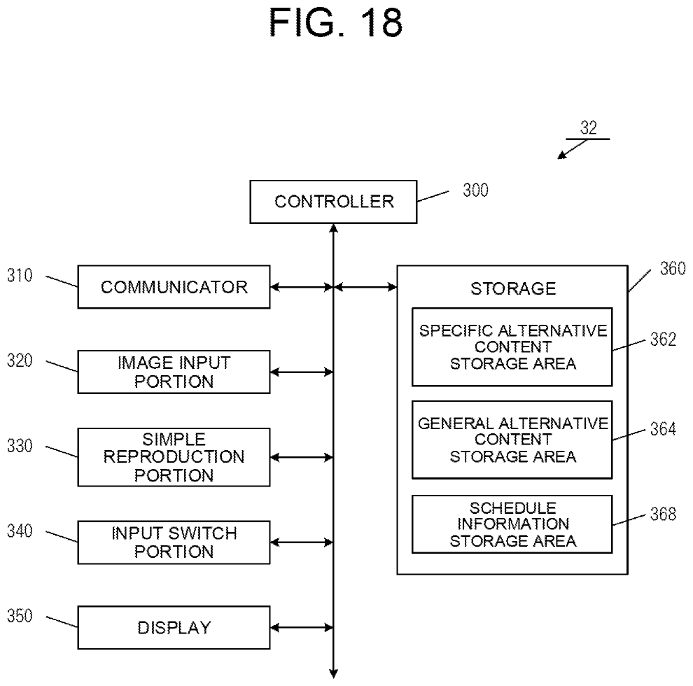

Next, a second embodiment will be described. The second embodiment differs from the first embodiment in that the priority of alternative content is determined not by the management server device but by the display device. In the embodiment FIG. 2 of the first embodiment is replaced with FIG. 17 and FIG. 7 is replaced with FIG. 18. Some of the processes of the second embodiment are different from those of the first embodiment. The same functional portions and processing are denoted by the same reference numerals, and description thereof will be omitted.

The management server device 12 according to the present embodiment does not store the priority information 130 unlike the management server device 10 according to the first embodiment. The display device 32 of the present embodiment has a schedule information storage area 368 in the storage 360 unlike the display device 30 of the first embodiment.

As the main processing of the management server device 12 of the present embodiment, the processing in which a part of the flow shown in FIG. 9 is modified is executed. Specifically, the processing in step S118 is skipped, and in step S120, the controller 100 transmits the simple reproduction display request including the schedule information to the display device 30.

As the main processing of the display device 32 of the present embodiment, the processing in which a part of the flow shown in FIG. 12 is modified is executed. Specifically, in step S170 the controller 300 determines whether the simple reproduction display request including the schedule information has been received. In addition, in step S172, when the simple reproduction display request including the schedule information is received, the controller 300 stores the received schedule information in the schedule information storage area 368. Then, during the processing in step S172 and step S174, the controller 300 determines the priority based on the schedule information stored in the schedule information storage area 368. The priority is determined by the same process as step S118 in the first embodiment.

According to the embodiment, the priority for the alternative content items can be determined by the display device 30 instead of the management server device 10. Therefore, it is possible to distribute the load of the processing for determining the priority.

### 3. THIRD EMBODIMENT

Next, a third embodiment will be described. The third embodiment is an embodiment in which the transmission of the alternative content is initiated when the transmission of the content is started.

In the present embodiment, when transmitting content to the control device 20, the management server device 10 refers to the schedule information, and specifies the content to be output by the control device 20 at the time of transmitting the content. Then, the specified alternative content corresponding to the specified content and the general alternative content are transmitted to the display device 30. The display device 30 stores the specific alternative content received from the management server device 10 in the specific alternative content storage area 362, and stores the

received general alternative content in the general alternative content storage area 364.

Then, the management server device 10 transmits the simple reproduction display request to the display device 30. The display device 30 simply reproduces and displays the specific alternative content storage area 362 if the specific alternative content storage area 362 can be reproduced by the simple reproduction portion 330 based on the reception of the simple reproduction display request. When the special alternative content cannot be reproduced by the simple reproduction portion 330, the display device 30 reproduces and displays the general alternative content,

According to the embodiment, since only the specific alternative content corresponding to the content output by the control device 20 at the time of content transmission is transmitted to the display device 30 as the specific alternative content, it is expected that the load on the display device 30 is reduced.

### 4. APPLICATION EXAMPLE

The example of FIG. 1 shows a diagram in which two display devices 30 are connected to one management server device 10. However, in reality, a considerable number (for example, 100 or more) of display devices 30 may be connected to one management server device 10. In such a case, when the management server device 10 converts content for each display device 30, the time for converting the content increases. As a result, it takes time to complete transmission of content,

Therefore, the content may be converted into a content that can be reproduced by the simple reproduction portion 330 having a standard capability from among the display devices 30 connected to the management server device 10, and may be stored in the specific alternative content storage area 126. Then, it is assumed that the alternative content including the specific alternative content storage area 126 and the general alternative content storage area 128 is transmitted to each display device 30. In this way, among the display devices 30 connected to the management server device 10, in the display device 30 having the simple reproduction portion 330 having a standard capability or more, the alternative content based on the specific alternative content storage area 126 can be simply reproduced by the simple reproduction portion 330.

Among the display devices 30 connected to the management server device 10, the display device 30 having the simple reproduction portion 330 that does not meet the standard capability cannot reproduce the alternative content based on the specific alternative content storage area 126 by the simple reproduction portion 330. Even in such a display device 30, it is possible to display alternative content based on the general alternative content storage area 128.

In this manner, even when a considerable number of display devices 30 are connected to the management server device 10, it is possible to display alternative content on the display device 30 even if an administrator or advertiser does not prepare alternative content, and also does not convert content for each display device 30. Since the alternative content displayed by the display device 30 is determined by display device 30, the alternative content suitable for the display device 30 can be displayed. Also, the administrator can reduce the work necessary for displaying the alternative content.

### 5. MODIFICATION EXAMPLE

The present invention is not limited to the embodiments described above, and various modifications may be possible. That is, an embodiment obtained by combining appropriately modified technical means is also included in the technical scope of the present invention without departing from the scope of the present invention.

Furthermore, although the above-described embodiments have been described as displaying image content, audio content or moving picture content with audio may be output as the content. In this case, the control device 20 outputs an audio signal together with the image signal, and the display device 30 receives the audio signal, and outputs the received audio signal from the audio output portion including a speaker or the like.

Moreover, although the embodiments mentioned above are demonstrated separately for convenience of explanation, the embodiments may be combined and executed in the technically possible range.

In the embodiment, a program that operates on each device is a program (a program that causes a computer to function) that controls a CPU or the like so as to realize the functions of the above-described embodiment. The information handled by these devices is temporarily stored in a temporary storage device (for example, RAM) at the time of processing, and then stored in a storage device such as various read only memory (ROM) and HDD, and read out, modified and written by the CPU as necessary.

Here, the recording med for storing the program may be a semiconductor medium (for example, a ROM, a non-volatile memory card, etc.), an optical recording medium/magneto-optical recording medium (for example, digital versatile disc (DVD), magneto optical disc (MO)), (MD), compact disc (CD), Blu-ray Disc (BD) (registered trademark)), or magnetic recording media (for example, magnetic tape, flexible disk). Moreover, not only the functions of the above-described embodiment can be realized by executing the loaded program, but also, the functions of the present invention may be realized by processing in cooperation with the operating system or other application programs based on the instructions of the program.

In the case of distribution in the market, the program can be distributed by storing in a portable recording medium, or can be transferred to a server computer connected via a network such as the Internet. In this case, the storage device of the server computer is also included in the present invention.

What is claimed is:

1. A content display system comprising:
a server device which transmits content;
a display device which displays the content; and
a display control device which controls to display the content transmitted from the server device on the display device, wherein
the server device includes a first controller which transmits, to the display device, a plurality of alternative content items including first alternative content corresponding to the content, the display of which is controlled by the display control device, and second alternative content other than the first alternative content, and controls to transmit an alternative content display request for requesting display of at least one of the alternative content items to the display device, and
the display device includes:
a storage which stores the alternative content items received from the server device, and
a second controller which determines the alternative content to be displayed from among the alternative content items when the alternative content display request is received, and controls to display the determined alternative content.

2. The content display system according to claim 1,
wherein the first controller determines priority of the alternative content to be displayed by the display device based on a schedule of the content, and transmits the alternative content display request comprising information of the priority to the display device, and
wherein the second controller determines the alternative content to be displayed based on the priority.

3. The content display system according to claim 1,
wherein the first controller transmits, to the display device, schedule information which is information related to a schedule of the content,
the storage stores the received schedule information, and
the second controller determines the alternative content to be displayed among the alternative content items based on the schedule information.

4. The content display system according to claim 1,
wherein the first controller converts the alternative content and then transmits the converted alternative content to the display device.

5. The content display system according to claim 4.
wherein the first controller converts the alternative content by performing at least one of frame rate reduction, bit rate reduction and content format conversion on the alternative content.

6. A display device connectable to a server device which transmits content and a display control device which performs display control based on the content transmitted from the server device, the display device comprising:
a controller which receives, from the server device, a plurality of alternative content items including first alternative content corresponding to the content, the display of which is controlled by the display control device, and second alternative content other than the first alternative content;, receives an alternative content display request for requesting display of at least one of the alternative content items from the server device, determines the alternative content to be displayed from among the alternative content items when the alternative content display request is received, and controls to display the determined alternative content.

7. A display method for a display device connectable to a server device which transmits content and a display control device which performs display control based on the content transmitted from the server device, the method comprising:
receiving, from the server device, a plurality of alternative content items including first alternative content corresponding to the content, the display of which is controlled by the display control device, and second alternative content other than the first alternative content;
receiving an alternative content display request for requesting display of at least one of the alternative content items from the server device;
determining alternative content to be displayed from among the alternative content items when the alternative content display request is received, and
displaying the determined alternative content.

8. A non-transitory recording medium storing a program that causes the display method according to claim a to be implemented by a computer of a display device connectable to a server device which transmits content and a display control device which performs display control based on the content transmitted from the server device.
